(19) United States
(12) Patent Application Publication
(10) Pub. No.: US 2024/0100425 A1
(43) Pub. Date: Mar. 28, 2024

(54) Method for Displaying Skill Effect in Game

(71) Applicant: NETEASE (HANGZHOU) NETWORK CO.,LTD., Hangzhou, Zhejiang (CN)

(72) Inventor: Xianlun GUO, Hangzhou, Zhejiang (CN)

(21) Appl. No.: 17/920,815

(22) PCT Filed: Apr. 28, 2021
(86) PCT No.: PCT/CN2021/090720

§ 371 Date: Oct. 24, 2022

(30) Foreign Application Priority Data
Jan. 6, 2021 (CN) 202110013591.6

(51) Int. Cl. A63F 13/52; A63F 13/42

(52) U.S. Cl. CPC A63F 13/52; A63F 13/42; A63F 13/285; A63F 2300/538; A63F 2300/6638

(57) ABSTRACT

Embodiments of the present disclosure disclose a method and device for displaying a skill effect in a game. The method is applied to a mobile terminal, a graphical user interface is obtained by rendering on a screen of the mobile terminal, the graphical user interface at least includes a skill control, and the method comprises: in response to a touch operation acting on the skill control, displaying a skill effect corresponding to the skill control, and acquiring a first map collected by a camera of the mobile terminal; acquiring a second map corresponding to the skill effect; combining the first map with the second map based on a display area of the skill effect, to obtain a third map; and displaying the third map on the graphical user interface.

### CROSS-REFERENCE TO RELATED APPLICATIONS

The present disclosure claims benefit of Chinese Patent Application No. 202110013591.6, filed to the China Patent Office on Jan. 6, 2021, entitled “Method and Device for Displaying Skill Effect in Game”, the contents of which are hereby incorporated by reference in its entirety.

### TECHNICAL FIELD

The present disclosure relates to the field of display interaction, and in particular, to a method for displaying a skill effect in a game.

### BACKGROUND

At present, in mobile games, a preset map or a sequence map is usually used for implementation of an explosion-type skill effect in the games, for example, as shown in the upper half part of FIG. 1, in the process of displaying an explosion-type skill effect, the effect of an animated mushroom cloud can be displayed, and as shown in the lower half part of FIG. 1, after the explosion-type skill effect is displayed, a remaining trace after explosion, for example, a crater effect, can be displayed.

However, as the described map is always preset and the pattern of the map is fixed, players are prone to aesthetic fatigue when they repeatedly watch the special effect during the game, which lacks interactivity and fun with players.

In view of the described problems, no effective solution has been proposed yet.

### SUMMARY

According to one aspect of the embodiments of the present disclosure, a method for displaying a skill effect in a game is provided. The method is applied to a mobile terminal, a graphical user interface is obtained by rendering on a screen of the mobile terminal, the graphical user interface at least includes a skill control, and the method comprises: in response to a touch operation acting on the skill control, displaying a skill effect corresponding to the skill control, and acquiring a first map collected by a camera of the mobile terminal, wherein the first map is an image describing an environment where the mobile terminal is located; acquiring a second map corresponding to the skill effect, wherein the second map is a static map describing a skill effect displaying result; combining the first map with the second map based on a display area of the skill effect, to obtain a third map; and displaying the third map in the graphical user interface.

Optionally, combining the first map with the second map based on the display area of the skill effect, to obtain the third map comprises: processing the first map according to parameter information of the display area, to obtain a processed first map; and attaching the second map onto the processed first map according to the parameter information of the display area, to obtain the third map.

Optionally, the parameter information comprises one or more pieces of the following information: position information of the display area, size information of the display area, and shape information of the display area.

Optionally, processing the first map according to parameter information of the display area, to obtain the processed first map comprises: cropping the first map according to the position information or size information of the display area, to obtain a cropped first map; and performing feathering processing on the edge of the cropped first map, to obtain the processed first map.

Optionally, attaching the second map onto the processed first map according to the parameter information of the display area, to obtain the third map comprises: attaching the second map onto the processed first map according to the position information of the display area, to obtain the third map.

Optionally, after combining the first map with the second map based on the display area of the skill effect to obtain the third map and displaying the third map in the graphical user interface, the method further comprises: combining a preset map with the third map based on the display area to obtain a fourth map, wherein the preset map is a static map describing a preset effect of the screen; and displaying the fourth map on the graphical user interface, and controlling the mobile terminal to vibrate.

Optionally, before combining the first map with the second map based on the display area of the skill effect to obtain the third map and displaying the third map in the graphical user interface, the method further comprises: determining whether the focal length of the camera is fixed; in response to the focal length of the camera is fixed, performing zooming processing on the first map according to a preset focal length, to obtain a zoomed first map; and combining the zoomed first map with the second map based on the display area, to obtain the third map.

Optionally, in response to the focal length of the camera is not fixed, the method further comprises: adjusting the focal length of the camera according to the preset focal length; and acquiring the first map collected by an adjusted camera.

Optionally, displaying a skill effect corresponding to the skill control comprises: acquiring a fifth map corresponding to the skill effect, wherein the fifth map is an image describing a skill effect displaying process corresponding to the skill control; and displaying the fifth map in the graphical user interface.

Optionally, an image collected by the camera in real time is acquired to obtain the first map.

According to another aspect of the embodiments of the present disclosure, a device for displaying a skill effect in a game is also provided. The device is applied to a mobile terminal, a graphical user interface is obtained by rendering on a screen of the mobile terminal, the graphical user interface at least comprises a skill control, and the device comprises: a first acquisition component, configured to display, in response to a touch operation acting on the skill control, a skill effect corresponding to the skill control, and acquire a first map collected by a camera of the mobile terminal, wherein the first map is an image describing an environment where the mobile terminal is located; a second acquisition component, configured to acquire a second map corresponding to the skill effect, wherein the second map is a static map describing a skill effect displaying result; a combination component, configured to combine the first map with the second map based on a display area of the skill effect, to obtain a third map; and a display component, configured to display the third map on the graphical user interface.

According to another aspect of the embodiments of the present disclosure, a non-transitory computer readable storage medium is further provided. The non-transitory computer readable storage medium stores a computer program, on which at least one computer program is stored, the at least one computer program being executed by a processor to implement the following steps: in response to a touch operation acting on the skill control, displaying a skill effect corresponding to the skill control, and acquiring a first map collected by a camera of the mobile terminal, wherein the first map is an image describing an environment where the mobile terminal is located; acquiring a second map corresponding to the skill effect, wherein the second map is a static map describing a skill effect displaying result; combining the first map with the second map based on a display area of the skill effect, to obtain a third map; and displaying the third map in the graphical user interface.

According to another aspect of the embodiments of the present disclosure, a processor is further provided, and the processor executes at least one executable instruction stored in the memory, wherein the at least one executable instruction comprises: in response to a touch operation acting on the skill control, displaying a skill effect corresponding to the skill control, and acquiring a first map collected by a camera of the mobile terminal, wherein the first map is an image describing an environment where the mobile terminal is located; acquiring a second map corresponding to the skill effect, wherein the second map is a static map describing a skill effect displaying result; combining the first map with the second map based on a display area of the skill effect, to obtain a third map; and displaying the third map in the graphical user interface.

### BRIEF DESCRIPTION OF THE DRAWINGS

The drawings illustrated herein are used for providing further understanding of the present disclosure and constitute a part of some embodiments of the present disclosure, and the illustrative embodiments of the present disclosure and illustrations thereof are used for explaining the present disclosure, rather than constitute inappropriate limitation on the present disclosure. In the drawings:

FIG. 1 is a schematic diagram of an explosion effect according to the related art;

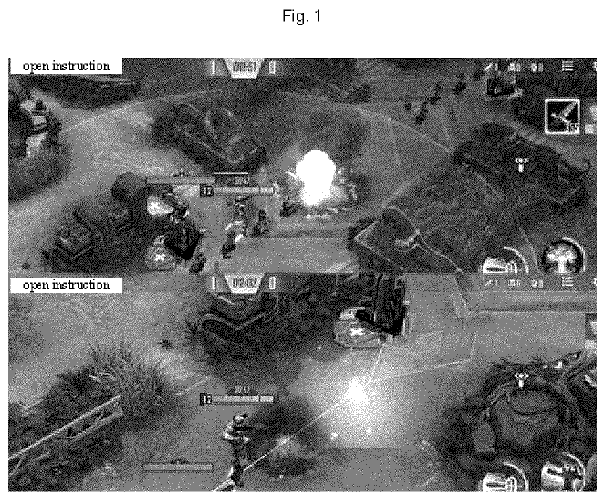

FIG. 2 is a flowchart of a method for displaying a skill effect in a game according to an embodiment of the present disclosure;

FIG. 3 is a schematic diagram of an optional effect of a penetrated crater left after explosion according to an embodiment of the present disclosure;

FIG. 4 is a schematic diagram of an optional effect of an explosion process according to an embodiment of the present disclosure; and

FIG. 5 is a schematic diagram of a device for displaying a skill effect in a game according to an embodiment of the present disclosure.

### DETAILED DESCRIPTION OF THE EMBODIMENTS

In order to enable those skilled in the art to understand the solutions of some embodiments of the present disclosure better, hereinafter, the technical solutions in the embodiments of the present disclosure will be described clearly and thoroughly with reference to the accompanying drawings of embodiments of the present disclosure. Obviously, the embodiments as described are only some of the embodiments of the present disclosure, and are not all the embodiments. All other embodiments obtained by a person of ordinary skill in the art based on the embodiments of the present disclosure without any inventive effort shall all fall within the scope of protection of the present disclosure.

It should be noted that the terms “first”, “second” etc., in the description, claims, and accompanying drawings of the present disclosure are used to distinguish similar objects, and are not necessarily used to describe a specific sequence or order. It should be understood that the data so used may be interchanged where appropriate so that the embodiments of the present disclosure described herein can be implemented in sequences other than those illustrated or described herein. In addition, the terms “comprise” and “have”, and any variations thereof are intended to cover a non-exclusive inclusion, for example, a process, method, system, product, or device that comprises a series of steps or units is not necessarily limited to those steps or units that are clearly listed, but may comprise other steps or units that are not clearly listed or inherent to such process, method, product, or device.

According to one aspect of the embodiments of the present disclosure, a method for displaying a skill effect in a game is provided. It should be noted that the steps illustrated in the flowchart of the drawings can be executed in a computer system such as a set of computer-executable instructions, and although a logical order is shown in the flowchart, in some cases, the steps shown or described can be executed in a different order from that described herein.

Optionally, the method is applied to a mobile terminal, and a graphical user interface is obtained by rendering on a screen of the mobile terminal, the graphical user interface at least comprising a skill control.

The mobile terminal may be a terminal used by a player, such as a smart phone, a tablet computer, and a notebook computer. A game client is installed on the mobile terminal, and the player plays an online game by logging in to the game client. Different games provide a different graphical user interface for players, the interfaces can be displayed on a display screen of the mobile terminal; and a game scene, a skill control, an operation control (for example, a control for controlling the movement of a virtual character), an interaction control (a chat box, a voice input control, etc.), a game setting control, etc. can be displayed on the graphical user interface, which is not specifically limited in the present disclosure.

It should be noted that the embodiments of the present disclosure mainly aim at the interaction of the explosion-type skill effect, and therefore, the described skill control can release an explosion skill, so that a corresponding explosion effect can be displayed on the graphical user interface.

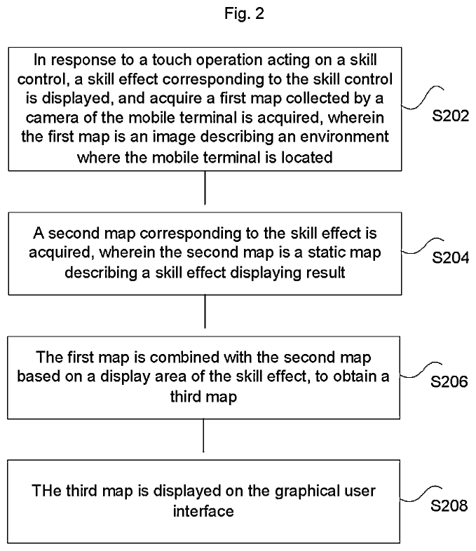

FIG. 2 is a flowchart of a method for displaying a skill effect in a game according to an embodiment of the present disclosure. As shown in FIG. 2, the method comprises the following steps:

Step S202, in response to a touch operation acting on a skill control, a skill effect corresponding to the skill control is displayed, and acquire a first map collected by a camera of the mobile terminal is acquired, wherein the first map is an image describing an environment where the mobile terminal is located.

The screen of an existing mobile terminal is usually a touch screen. A player can directly perform an operation on the graphical user interface by means of performing a touch operation on the screen. Upon detection of a touch operation, an operation that the player wants to perform can be determined based on a position triggered by the touch operation, for example, when a touch operation of an explosion skill control is detected, it can be determined that the player wants to release an explosion skill, and then a release process and a release result of the explosion skill can be displayed on the graphical user interface.

The camera may be a built-in camera of the mobile terminal. An existing mobile terminal usually has a front-facing camera and a rear-facing camera. In order to create an effect that a screen is penetrated by an explosion, real-time photographing can be performed according to the rear-facing camera to generate a dynamic map, so as to obtain the first map. In this case, a real-time scene behind the mobile terminal is described in the first map.

Optionally, an image collected by the camera in real time may be acquired to obtain the first map.

It should be noted that, in order to acquire the first image, it is necessary to ensure acquiring the photographing permission of the camera, and the permission may be acquired in advance before the start of the game, or the permission may be acquired by querying the player when it is necessary to acquire the first image. In the embodiment of the present disclosure, in order to avoid affecting the game experience due to the interruption of a skill effect, the photographing permission of the camera may be acquired in advance before the start of the game, for example, the permission is acquired when a game client is installed, or the permission is acquired when the game client logs in, which may be set according to an actual application scenario and security requirements.

Step S204: a second map corresponding to the skill effect is acquired, wherein the second map is a static map describing a skill effect displaying result.

With regard to an explosion-type skill, a complete explosion effect can be divided into an explosion process effect and a remaining trace effect after explosion. In order to create an effect that a screen is penetrated by an explosion, the second map in the described steps can refer to a map of a peripheral portion of a crater appearing after an explosion.

In an optional embodiment, for different skill effects, different static maps may be preset to describe the result display of the skill effect. All preset maps are stored in a server. Upon detection of a touch operation of a skill control, a mobile terminal may send a request to the server. The server returns all maps corresponding to the skill effect to the mobile terminal. The mobile terminal renders and displays the maps.

Step S206: the first map is combined with the second map based on a display area of the skill effect, to obtain a third map.

The display area of the described steps may refer to an area which is designated by a player or set by a game for displaying a skill effect. For example, when a player needs to release an explosion skill, the player may release the explosion skill at a designated position based on a release range, and the explosion effect is displayed in the area corresponding to the position. For another example, when a player needs to release an explosion skill, the player can select a release direction of the explosion skill, so that the game system can determine a display area of the explosion effect based on a set requirement.

In an optional embodiment, in order to create an effect that a screen of a mobile terminal is penetrated by an explosion, a first map generated by a camera in real time and a second map may be combined, so as to keep an external portion of a crater appearing after an explosion, and replace a middle portion with the first map, thereby obtaining a final third map.

The camera can paragraph a scene behind the whole mobile terminal, the display areas of the skill effects are different, and the scenes corresponding to the effects that a screen is penetrated by an explosion are different, therefore, in the embodiments of the present disclosure, after the first map is acquired, cropping and edge feathering processing can be performed on the first map based on the display areas of the skill effects, to obtain a dynamic map corresponding to the display areas, and the dynamic map corresponding to the display areas is combined with the second map to obtain a final third picture.

Step S208: the third map is displayed in the graphical user interface.

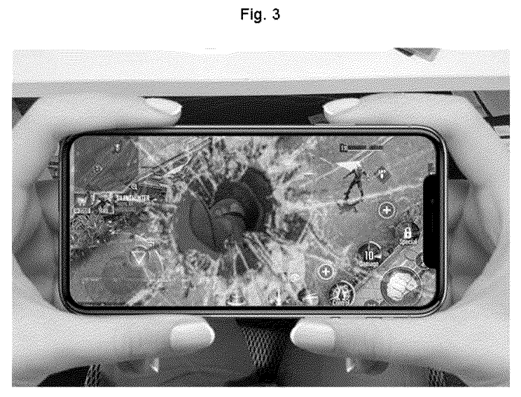

In an optional embodiment, the third map may be displayed in the display area of the skill effect, so that the player can view, in the middle portion of the crater after explosion, the scene behind the mobile terminal in real time. For example, the effect of a crater penetrating the screen remaining after the explosion is shown in FIG. 3.

By means of the solution provided in the embodiments of the present disclosure, in response to a touch operation acting on a skill control, a skill effect corresponding to the skill control is displayed, a first map collected by a camera of the mobile terminal is acquired, after a second map corresponding to the skill effect is acquired, the first map and the second map may be combined based on a display area of the skill effect to obtain a third map, and the third map is displayed on the graphical user interface. Since the third map displayed in the graphical user interface is generated based on the first map collected in real time by the camera, it creates a visual effect that a screen of a mobile terminal is penetrated by an explosion, so that the third map can change with the movement of the mobile terminal, and is no longer a fixed content, thereby achieving the technical effect of improving the interactivity of a skill effect and increasing the interestingness of a game, and further solving the technical problem in the related art that the interaction method is relatively fixed as a skill effect is achieved by presetting a map or a sequence map, which affects the game experience.

Optionally, the first map is combined with the second map based on the display area of the skill effect, to obtain the third map comprises: the first map is processed according to parameter information of the display area, to obtain a processed first map; and the second map is attached onto the processed first map according to the parameter information of the display area, to obtain the third map.

Optionally, the parameter information may comprise one or more pieces of the following information: position information of the display area, size information of the display area, and shape information of the display area.

The position information in the described steps may refer to the specific position coordinates displayed on the graphical user interface by the skill effect. Size information may refer to a display size of a skill effect result. Shape information may refer to a display shape of a skill effect result. For example, in most games, the shape of a crater after explosion is round, but is not limited thereto. For different games, display perspectives of game scenes are different, and the shape of a crater after explosion may change, for example, may be oval, etc.

In an optional embodiment, in order to improve the display effect of the third map, the first map may be processed based on the display position, the size and the shape of a crater after explosion, to obtain a map meeting the skill effect, and then the map is combined with a map of an edge portion of the crater, to obtain a final third map.

Optionally, the first map is processed according to parameter information of the display area, to obtain the processed first map comprises: the first map is cropped according to the position information or size information of the display area, to obtain a cropped first map; and feathering processing is performed on the edge of the cropped first map, to obtain the processed first map.

The feathering processing in the step may refer to virtualizing the edge of a map, so as to achieve an effect of the gradual change of the edge and ensure a natural connection between different images.

In an optional embodiment, firstly, an area that needs to be reserved in the first map may be determined based on the display position of a crater after explosion, and then the first map is cropped according to the size and shape of the crater after explosion, to obtain a map matching the crater after explosion; furthermore, feathering processing is performed on the edge of the map, to obtain a map that has the best effect and matches the crater after explosion, i.e. the first map.

Optionally, the second map is attached onto the processed first map according to the parameter information of the display area, to obtain the third map comprises: the second map is attached onto the processed first map according to the position information of the display area, to obtain the third map.

Since the first map subjected to cropping and feathering processing is located in the middle portion of a crater effect, and the second map is an edge portion of the crater effect, in an optional embodiment, the second map can be attached to the first map subjected to cropping and feathering processing, to obtain a final third map. In other words, the first map subjected to cropping and feathering processing is placed on the bottom layer, and the second map is superimposed on the first map subjected to cropping and feathering processing.

Optionally, after the first map is combined with the second map based on the display area of the skill effect to obtain the third map and the third map is displayed in the graphical user interface, the method further comprises: a preset map is combined with the third map based on the display area to obtain a fourth map, wherein the preset map is a static map describing a preset effect of the screen; and the fourth map is displayed on the graphical user interface, and the mobile terminal is controlled to vibrate.

The preset map in the step may refer to a preset map showing a screen cracking effect, for example, a map including a screen crack, but is not limited thereto.

In an optional embodiment, in order to further improve a display effect that a screen of a mobile terminal is penetrated by an explosion, a screen cracking map may be superimposed based on the third map, wherein at a position corresponding to the display area of the crater after explosion, the screen cracking effect may be that a large hole is displayed on the screen, and the screen crack radiates from the large hole to the surroundings. In addition, the mobile terminal can be controlled to vibrate, and an effect that the mobile terminal is shocked by an explosion is created. Therefore, the mobile terminal can vibrate at the beginning of an explosion process or in the whole display process of the explosion special effect, but the vibration amplitude slowly decreases.

Optionally, before the first map is combined with the second map based on the display area of the skill effect to obtain the third map and the third map is displayed in the graphical user interface, the method further comprises: determining whether the focal length of the camera is fixed; in response to the focal length of the camera is fixed, zooming processing is performed on the first map according to a preset focal length, to obtain a zoomed first map; and the zoomed first map is combined with the second map based on the display area, to obtain the third map.

The preset focal length in the step may refer to the focal length of the eyes of a player, and the specific value may be determined according to an actual usage situation, may be a preset fixed value, and may also be the focal length of the eyes determined by photographing the photo of the player by a front-facing camera.

The zooming process in the step may refer to, but is not limited to, zooming-up and zooming-down. In the embodiment of the present disclosure, zooming-up is taken as an example for description.

In an optional embodiment, in order to ensure that a map generated by a camera in real time conforms to a visual field effect of the eyes, calibration adjustment may be performed on the first map based on a relationship between the focal length of the camera and the visual field of the eyes. Most rear cameras of mobile terminals are wide-angle lenses and have a fixed focal length. Therefore, when it is determined that the focal length of the camera is a fixed value and cannot be modified, a dynamic map photographed by a rear camera can be quantitatively zoomed up based on a preset focal length to make same conform to the perspective effect of penetration, and furthermore, the dynamic map subjected to zooming up is further combined with an edge map of the crater after explosion, to obtain a final third image.

Optionally, in response to the focal length of the camera is not fixed, the method further comprises: the focal length of the camera is adjusted according to the preset focal length; and the first map collected by the adjusted camera is acquired.

In an optional embodiment, for some mobile terminals, the focal length of a camera can be set manually by a player or others; therefore, when it is determined that the focal length of the camera is not a fixed value and can be modified, the focal length of the camera can be controlled to be adjusted, so that the adjusted focal length of the camera matches the focal length of the eyes. In this case, a dynamic map can be photographed by the camera, so that the acquired dynamic map conforms to a perspective effect of penetration.

Optionally, the skill effect corresponding to the skill control is displayed comprises: a fifth map corresponding to the skill effect is acquired, wherein the fifth map is an image describing a skill effect displaying process corresponding to the skill control; and the fifth map is displayed in the graphical user interface.

The fifth map in the step may be a dynamic map preset in an explosion process or a technical effect produced by a special effect system.

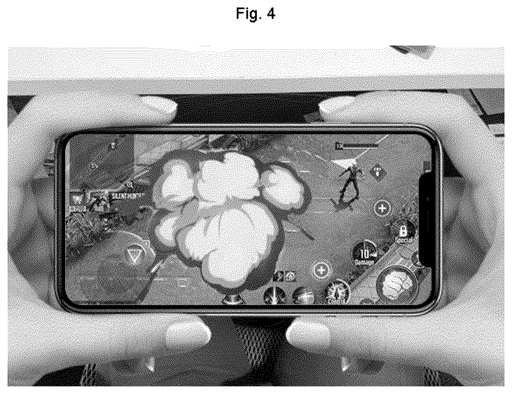

In an optional embodiment, upon detection of a touch operation of an explosion-type skill control, it can be determined that a player wants to release an explosion skill, and then a fifth map can be displayed in the display area of the explosion skill, as shown in FIG. 4.

According to an embodiment of the present disclosure, a device for displaying a skill effect in a game is further provided. The device can execute the method for displaying a skill effect in a game in the described embodiment. The specific implementation solution and preferred application scenario in this embodiment are the same as those in the described embodiment, and will not be repeated here.

Optionally, the device is applied to a mobile terminal, and a graphical user interface is obtained by rendering on a screen of the mobile terminal, the graphical user interface at least comprising a skill control.

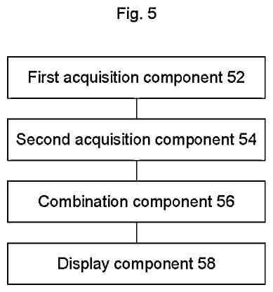

FIG. 5 is a schematic diagram of a device for displaying a skill effect in a game according to an embodiment of the present disclosure. As shown in FIG. 5, the device comprises:
a first acquisition component 52, configured to display, in response to a touch operation acting on a skill control, a skill effect corresponding to the skill control, and acquire a first map collected by a camera of the mobile terminal, wherein the first map is an image describing an environment where the mobile terminal is located;
a second acquisition component 54, configured to acquire a second map corresponding to the skill effect, wherein the second map is a static map describing a skill effect displaying result;
a combination component 56, configured to combine the first map with the second map based on a display area of the skill effect, to obtain a third map; and
a display component 58, configured to display the third map on the graphical user interface.

It should be noted that the first acquisition component 52, the second acquisition component 54, the combination component 56 and the display component 58 can run in a terminal as part of a device. A processor in the terminal can perform the functions implemented by the components. The terminal can also be a smart phone (such as an Android phone, or an iOS phone), a tablet computer, a Mobile Inter Device (MID), Portable Android Device (PAD) or other terminal devices.

Optionally, the combination component comprises: a processing unit, configured to process the first map according to parameter information of the display area, to obtain a processed first map; and a combination unit, configured to attach the second map onto the processed first map according to the parameter information of the display area, to obtain the third map.

It should be noted that the processing unit and the combination unit can run in the terminal as part of the device. The processor in the terminal can perform the functions implemented by the units.

Optionally, the processing unit comprises: a cropping subunit, configured to crop the first map according to the position information or size information of the display area, to obtain a cropped first map; a feathering subunit, configured to perform feathering processing on the edge of the cropped first map, to obtain the processed first map.

It should be noted that the cropping subunit and the feathering subunit can run in the terminal as part of the device. The processor in the terminal can perform the functions implemented by the subunits.

Optionally, the combination unit is further configured to attach the second map onto the processed first map according to the position information of the display area, to obtain the third map.

Optionally, the device further comprises: an attachment component, configured to combine a preset map with the third map based on the display area to obtain a fourth map, wherein the preset map is a static map describing a preset effect of the screen; and a control component, configured to display the fourth map on the graphical user interface, and control the mobile terminal to vibrate.

It should be noted that the attachment component and the control component can run in the terminal as part of the device. The processor in the terminal can perform the functions implemented by the components.

Optionally, the device further comprises: a determination component configured to determine whether the focal length of the camera is fixed; a processing component configured to perform, in response to the focal length of the camera is fixed, zooming processing on the first map according to a preset focal length, to obtain a zoomed first map; and the combination component is further configured to combine the zoomed first map with the second map based on the display area, to obtain a third map.

It should be noted that the determination component, the processing component and the combination component can run in the terminal as part of the device. The processor in the terminal can perform the functions implemented by the components.

Optionally, the device further comprises: an adjustment component, configured to adjust the focal length of the camera according to a preset focal length in response to the focal length of the camera is not fixed; and the second acquisition component is further configured to acquire the adjusted first map collected by the camera.

It should be noted that the adjustment component and the second acquisition component can run in the terminal as part of the device. The processor in the terminal can perform the functions implemented by the components.

Optionally, the first acquisition component comprises: an acquisition unit configured to acquire a fifth map corresponding to a skill effect, wherein the fifth map is an image describing a skill effect displaying process corresponding to the skill control; and a display unit configured to display the fifth map on the graphical user interface.

It should be noted that the acquisition unit and the display unit can run in the terminal as part of the device. The processor in the terminal can perform the functions implemented by the units.

Optionally, the first acquisition component is further configured to acquire an image collected by the camera in real time, to obtain the first map.

According to an embodiment of the present disclosure, a non-transitory computer readable storage medium is further provided. The non-transitory computer readable storage medium comprises a stored program which, when running, controls a device where the non-transitory computer readable storage medium is located to execute the method for displaying a skill effect in a game in the described embodiment.

Each of function modules provided in the embodiments of the present disclosure may run in the device for displaying a skill effect in a game, or similar devices, and may also be stored as a part of storage media.

Optionally, in the embodiment, the non-transitory computer readable storage medium stores a computer program, wherein the computer program is configured to be used to perform the method for displaying a skill effect in a game when running.

Optionally, in the embodiment, the non-transitory computer readable storage medium is configured to store the program codes used for performing the following steps: in response to a touch operation acting on the skill control, a skill effect corresponding to the skill control is displayed, and a first map collected by a camera of the mobile terminal is acquired, wherein the first map is an image describing an environment where the mobile terminal is located; a second map corresponding to the skill effect is acquired, wherein the second map is a static map describing a skill effect displaying result; the first map and the second map may be combined based on a display area of the skill effect to obtain a third map; the third map is displayed on the graphical user interface.

Optionally, in the embodiment, the storage medium may be further configured as the program codes of the steps in each alternative or preferred embodiment of the method for displaying a skill effect in a game.

According to an embodiment of the present disclosure, a processor for running a program is further provided. The processor is used for running the program which, when running, executes the method for displaying a skill effect in a game.

In the embodiment, the processor may execute program codes of the following steps in the method for displaying a skill effect in a game.

Optionally, in the embodiment, the processor maybe configured to execute the following steps: in response to a touch operation acting on the skill control, a skill effect corresponding to the skill control is displayed, and a first map collected by a camera of the mobile terminal is acquired, wherein the first map is an image describing an environment where the mobile terminal is located; a second map corresponding to the skill effect is acquired, wherein the second map is a static map describing a skill effect displaying result; the first map and the second map may be combined based on a display area of the skill effect to obtain a third map; the third map is displayed on the graphical user interface.

The processor executes various function applications and data processing by running the software program and module stored in the memory, namely implementing the method for displaying a skill effect in a game.

Those of ordinary skill in the art may understand that all or part of the steps in the method of the above embodiments may be performed by hardware related to the terminal devices instructed by a program. The program may be stored in a non-transitory computer readable storage medium. The storage media may include: a flash disk, a Read-Only Memory (ROM), a RAM, a magnetic disk or a compact disc.

The above figures describe the method for displaying a skill effect in a game of the present disclosure as an example. However, those skilled in the art should understand that there are various improvements to the method for displaying a skill effect in a game that can be made based on the contents of the present disclosure. Therefore, the scope of the present disclosure shall be determined by the contents of the attached claims.

The sequence number of the embodiments above of the present disclosure is only for description, but do not denote the preference of the embodiments.

In the embodiments of the present disclosure, the description of each embodiment has its own emphasis. For the part not detailed in a certain embodiment, please refer to the relevant description in other embodiments.

In the several embodiments provided in the present application, it should be understood that the disclosed technical content may be implemented in other manners. The device embodiment described above is only schematic. For example, the division of the components can be logical functional division, and there can be other division methods in the actual implementation, for example, multiple units or components can be combined or integrated into another system, or some features can be ignored or not executed. In addition, the mutual coupling or direct coupling or communication connection shown or discussed may be indirect coupling or communication connection through some interfaces, units or components, and may be in the form of electricity or other forms.

The units described as separate components may or may not be physically separated, and the components displayed as units may or may not be physical units, that is, may be located in one place, or may be distributed to multiple units. Some or all units can be selected according to the actual needs to achieve the purpose of the solutions of the embodiments.

In addition, functional units in the embodiments of the present disclosure may be integrated into one processing unit, or the units may exist alone physically, or two or more units are integrated into one unit. The integrated unit may be implemented in the form of hardware, and may also be implemented in the form of a software functional unit.

If the integrated unit is implemented in the form of a software functional unit and is sold or used as an independent product, the integrated unit can be stored in a non-transitory computer readable storage medium. Based on such understanding, the part of the technical solutions of some embodiments of the present disclosure that contributes in essence or to the prior art or all or part of the technical solutions may be embodied in the form of a software product stored in a storage medium. Several instructions are included in the storage medium to cause a computer device (which may be a personal computer, server or network device, etc.) to execute all or some of the steps of the methods of various embodiments of the present disclosure. The foregoing storage medium comprises: media such as a USB flash disk, a Read-Only Memory (ROM), a Random Access Memory (RAM), a removable hard disk, a magnetic disk, or an optical disk, and the like which can store program codes.

The contents above are only the preferred embodiments of the invention. It should be pointed out that for a person of ordinary skill in the technical field, several improvements and refinements can be made without departing from the principle of the invention, and these improvements and refinements shall also fall within the protection scope of the invention.

### INDUSTRIAL APPLICABILITY

In response to a touch operation acting on the skill control, a skill effect corresponding to the skill control is displayed, a first map collected by a camera of the mobile terminal is acquired, after a second map corresponding to the skill effect is acquired, the first map and the second map may be combined based on a display area of the skill effect to obtain a third map, and the third map is displayed on the graphical user interface. Since the third map displayed on the graphical user interface is generated based on the first map collected in real time by a camera, it creates a visual effect of penetration of a screen of the mobile terminal by an explosion, so that the third map can change with the movement of the mobile terminal, and is no longer a fixed content, thereby achieving the technical effect of improving the interactivity of a skill effect and increasing the interestingness of a game, and further solving the technical problem in the related art that the interaction method is relatively fixed as a skill effect is achieved by a preset map or a sequence map, which affects the game experience.

What is claimed is:

1. A method for displaying a skill effect in a game, wherein the method is applied to a mobile terminal, a graphical user interface is obtained by rendering on a screen of the mobile terminal, the graphical user interface at least comprises a skill control, and the method comprises:
in response to a touch operation acting on the skill control, displaying a skill effect corresponding to the skill control, and acquiring a first map collected by a camera of the mobile terminal, wherein the first map is an image describing an environment where the mobile terminal is located;
acquiring a second map corresponding to the skill effect, wherein the second map is a static map describing a skill effect displaying result;
combining the first map with the second map based on a display area of the skill effect, to obtain a third map; and
displaying the third map on the graphical user interface.

2. The method as claimed in claim 1, wherein combining the first map with the second map based on the display area of the skill effect, to obtain the third map comprises:
processing the first map according to parameter information of the display area, to obtain a processed first map; and
attaching the second map onto the processed first map according to the parameter information of the display area, to obtain the third map.

3. The method as claimed in claim 2, wherein the parameter information comprises at least one piece of the following information: position information of the display area, size information of the display area, and shape information of the display area.

4. The method as claimed in claim 3, wherein processing the first map according to parameter information of the display area, to obtain the processed first map comprises:
cropping the first map according to the position information or size information of the display area, to obtain a cropped first map; and
performing feathering processing on the edge of the cropped first map, to obtain the processed first map.

5. The method as claimed in claim 3, wherein attaching the second map onto the processed first map according to the parameter information of the display area, to obtain the third map comprises:
attaching the second map onto the processed first map according to the position information of the display area, to obtain the third map.

6. The method as claimed in claim 1, wherein after combining the first map with the second map based on the display area of the skill effect, to obtain the third map, the method further comprises:
combining a preset map with the third map based on the display area to obtain a fourth map, wherein the preset map is a static map describing a preset effect of the screen; and
displaying the fourth map on the graphical user interface, and controlling the mobile terminal to vibrate.

7. The method as claimed in claim 1, wherein before combining the first map with the second map based on the display area of the skill effect, to obtain the third map, the method further comprises:
determining whether the focal length of the camera is fixed;
in response to the focal length of the camera is fixed, performing zooming processing on the first map according to a preset focal length, to obtain a zoomed first map; and
combining the zoomed first map with the second map based on the display area, to obtain the third map.

8. The method as claimed in claim 7, wherein in response to the focal length of the camera is not fixed, the method further comprises:
adjusting the focal length of the camera according to the preset focal length; and
acquiring the first map collected by an adjusted camera.

9. The method as claimed in claim 1, wherein displaying the skill effect corresponding to the skill control comprises:
acquiring a fifth map corresponding to the skill effect, wherein the fifth map is an image describing a skill effect displaying process corresponding to the skill control; and
displaying the fifth map on the graphical user interface.

10. The method according to claim 1, wherein an image collected by the camera in real time is acquired to obtain the first map.

11. (canceled)

12. A non-transitory computer readable storage medium, storing a computer program, on which at least one computer program is stored, the at least one computer program being executed by a processor to implement the following steps:
in response to a touch operation acting on the skill control, displaying a skill effect corresponding to the skill control, and acquiring a first map collected by a camera of the mobile terminal, wherein the first map is an image describing an environment where the mobile terminal is located;
acquiring a second map corresponding to the skill effect, wherein the second map is a static map describing a skill effect displaying result;
combining the first map with the second map based on a display area of the skill effect, to obtain a third map; and
displaying the third map on the graphical user interface.

13. A processor, executing at least one executable instruction stored in the memory, wherein the at least one executable instruction comprises:
in response to a touch operation acting on the skill control, displaying a skill effect corresponding to the skill control, and acquiring a first map collected by a camera of the mobile terminal, wherein the first map is an image describing an environment where the mobile terminal is located;
acquiring a second map corresponding to the skill effect, wherein the second map is a static map describing a skill effect displaying result;
combining the first map with the second map based on a display area of the skill effect, to obtain a third map; and
displaying the third map on the graphical user interface.

14. The method according to claim 1, wherein the photographing permission of the camera is acquired in advance before the start of the game.

15. The method according to claim 1, wherein the skill control releases an explosion skill.

16. The method according to claim 15, wherein the skill effect is divided into an explosion process effect and a remaining trace effect after explosion, the second map is a map of a peripheral portion of a crater appearing after an explosion, and the first map is located in the middle portion of the crater.

17. The method according to claim 1, wherein the display area is designated by a player or set by the game for displaying the skill effect.

18. The method according to claim 5, wherein attaching the second map onto the processed first map by using the position information of the display area, to obtain the third map comprises:
placing the processed first map on the bottom layer; and
superimposing the second map on the processed first map, to obtain the third map.

19. The method according to claim 6, wherein the preset map is a preset map showing a screen cracking effect.

20. The method according to claim 7, wherein performing zooming processing on the first map according to the preset focal length, to obtain the zoomed first map comprises:
performing calibration adjustment on the first map based on a relationship between the focal length of the camera and the preset focal length.

21. The method according to claim 9, wherein the fifth map is a dynamic map preset in an explosion process or a technical effect produced by a special effect system.
